(19) United States
(12) Patent Application Publication
(10) Pub. No.: US 2012/0245028 A1
(43) Pub. Date: Sep. 27, 2012

(54) Methods for Use of Tetraalkyl Ammonium Halide Compositions as Post-emergence Higher Plant Herbicides

(76) Inventor: James B. Nabors, (US)

(21) Appl. No.: 13/426,660

(22) Filed: Mar. 22, 2012

Related U.S. Application Data
(60) Provisional application No. 61/466,978, filed on Mar. 24, 2011.

(51) Int. Cl. A01N 33/12; A01P 13/00; A01N 57/20

(52) U.S. Cl. 504/127; 504/345; 504/148

(57) ABSTRACT

Tetraalkyl ammonium halides are applied to a broad range of undesirable terrestrial plants for fast and effective herbicidal activity. It is desirable to use a herbicidally effective amount of the chemical formula R₁R₂N(+)R₃R₄ X(−), wherein, R₁ and R₂ are each independently C₁ to C₄ alkyl; R₃ and R₄ are each independently C₈ to C₁₆ alkyl; X is chloride or bromide. This herbicide may be used alone, or in combination with at least one additional herbicide.

This application claims the benefit of Provisional Application Ser. No. 61/466,978 filed Mar. 24, 2011.

### FIELD

The current disclosure relates generally to herbicides, and more specifically to methods of controlling unwanted higher terrestrial plants.

### BACKGROUND

The elimination of weeds and other undesirable plants in agricultural, horticultural and residential settings is an important market with a very significant economic value. There are many products available as solutions for this problem, but applicant desires new solutions that offer additional benefits, for example, methods that provide rapid and effective control of undesirable plants with a composition that is economic and environmentally friendly. The present disclosure provides these, and additional, benefits.

The active ingredients of the present invention include members of the substituted quaternary ammonium salt family. Tetraalkyl quaternary ammonium halide salts are best known for the bactericidal and algaecidal properties of the compounds. There are a number of industrial, household, medical and textile products based on these properties.

Tetraalkyl ammonium salts are also used as plant growth regulators. U.S. Pat. No. 3,884,670 discloses activity of trimethyl cycloalkyl quaternary salts as plant growth regulators. No herbicidal activity was reported for the compounds of this invention at foliar application rates to pea plants of up to 6 Kg/Ha, and following application, increases in green weight were observed along with increased vigor in tillers and foliage. U.S. Pat. No. 3,580,716 discloses use of tetraisopentyl ammonium salts as plant growth regulators for a variety of plants. The turf grasses sprayed with the '716 inventive compounds exhibited good color and robust growth four weeks after application with no indication of herbicidal effects.

WO9115120 relates to the use of certain very long chain quaternary ammonium compounds in plant protection for controlling and combating fungi. Several of the examples include phytotoxicity ratings for didecyl dimethyl ammonium chloride (DDAC) as a comparison compound to the long chain quaternary compounds. Young potato and sunflower plants were treated with DDAC solutions in concentrations up to 0.3% and subsequently were inoculated with fungus. While the phytotoxicity ratings of the long chain quaternary compounds were superior to DDAC, there was no indication that the DDAC killed these young plants.

United States Patent Application 20010051174 discloses use of substituted quaternary ammonium chloride compositions at concentrations between 0.00005% and 0.5% for protection of fruit trees and plants from destructive organisms. DDAC is specifically claimed as a mixture with benzalkonium chloride. There is no indication of phytotoxic effects of these quaternary ammonium compounds for the trees and plants treated with the compositions.

U.S. Pat. No. 3,984,570 discloses use of a range of surface active agents, including didecyl dimethyl ammonium bromide (DDAB), for control of overwintering fungal diseases in trees. In the first example, with small apple tree seedlings, severe phytotoxicity was observed following fungus inoculation and a treatment with 5% DDAB solution. However, in the second example, with infected field apple trees that were treated with 5% DDAB solution, the inventors make the following observation: “no obvious damage caused by the treatments and they had no effect upon the total number of growing buds”.

European Patent Application EP1044608 also discloses phytosanitary compositions that include quaternary ammonium compounds for preventative or curative treatment of diseases in plants and trees. Concentration of the quaternary compound, including didecyl dimethyl ammonium chloride, ranges between 10% and 30%. The inventors make the following statement regarding the product (column 2, lines 16-24): “The application of this phytosanitary product to plants, when the possibility of wounds exists, has given satisfactory results in the prevention of infections by bacteriums and fungus and especially against Pseudomonas Syringae in apple trees, pear trees, peach trees, nectarines, tomatoes, peppers and marrows, and against Erwinia Amylovora in apple trees and pear trees”. There is no reference to phytotoxicity for the compositions of this invention.

WO2008128557 and WO2008128658 disclose methods and quaternary ammonium halide compositions useful for simultaneous prevention of weeds, algae, bacteria, fungi and viruses by application to floors, surfaces and work tools in greenhouses and other enclosed structures. Data presented relate to prevention of seed germination by soaking seeds in an aqueous solution of DDAC, ethoxylated isotridecanol and isopropanol (4.3:2.3:1 ratio). While the data demonstrate effective prevention of germination for a number of different seeds, the reported effects may not be attributable to the DDAC alone. In fact, Pethybridge, et. al., [Plant Disease, Vol. 90 (7), 891-897, 2006] report no significant effect on germination of pyrethrum seed treated with a 12% solution of DDAC (Sporekill®) at a rate of 20 ml/kg of seed.

### SUMMARY

Applicant discovered, to his surprise, that tetraalkyl ammonium halides exhibit unexpected herbicidal properties, enabling fast and effective control of a broad range of undesirable terrestrial plants. Accordingly, the current disclosure is directed to various methods for controlling unwanted higher terrestrial plants using tetraalkyl ammonium halides.

In one aspect, a method includes controlling higher plants by the application of a herbicidally effective amount of at least one tetraalkyl ammonium halide to a higher plant.

In another aspect, the current disclosure is directed to methods of controlling an unwanted higher terrestrial plant comprising applying to the terrestrial plant a herbicidally effective amount of a tetraalkyl ammonium halide(s) of the chemical formula

R₁R₂N(+)R₃R₄X(−)

wherein, R₁ and R₂ are each independently C₁ to C₄ alkyl; R₃ and R₄ are each independently C₈ to C₁₆ alkyl; X is chloride or bromide, the methods comprising post-emergence application to the plant of an herbicidally effective dose of the composition.

In another aspect, the current disclosure is directed to methods of controlling an unwanted higher terrestrial plant comprising applying to the terrestrial plant a herbicidally effective amount of a tetraalkyl ammonium halide(s) of the chemical formula

R₁R₂N(+)R₃R₄X(−)

wherein, R₁ and R₂ are each independently C₁ to C₄ alkyl; R₃ and R₄ are each independently C₈ to C₁₆ alkyl; X is chloride or bromide, and at least one additional herbicide.

The above summary was intended to summarize certain embodiments of the present disclosure. Methods and compositions will be set forth in more detail, along with examples demonstrating efficacy, in the detailed description below. It will be apparent, however, that the detailed description is not intended to limit the present invention, the scope of which should be properly determined by the appended claims.

### DESCRIPTION OF EXEMPLARY EMBODIMENTS

The current disclosure is directed to, inter alia, a variety of methods of controlling higher terrestrial plants. In one embodiment, a method comprises applying a herbicidally effective amount of at least one tetraalkyl ammonium halide to a higher plant. Application may be by any of the variety of ways known to those skilled in the art, including spraying for example.

In another embodiment, the present disclosure is directed to methods of controlling unwanted higher terrestrial plants comprising the application of tetraalkyl ammonium halides of the chemical formula below for non-selective control of terrestrial plants.

R₁R₂N(+)R₃R₄X(−)

wherein, R₁ and R₂ are each independently C₁ to C₄ alkyl; R₃ and R₄ are each independently C₈ to C₁₆ alkyl; X is chloride or bromide. Exemplary members of this family have R₁ and R₂ as methyl, with R₃ and R₄ each independently as C₈ to C₁₆ alkyl, and X is chloride. A preferred form of tetraalkyl ammonium chloride has both R₁ and R₂ as methyl, and R₃ and R₄ with an alkyl chain of C₁₀, (CAS#7173-51-5). Application amounts may vary, but will include the application of herbicidally effective amounts.

The methods of the present invention are useful for inhibiting the growth of both mono- and dicotyledonous plants in a wide variety of higher plant applications. The higher (vascular) plants include plants in the kingdom Plantae that have specialized tissues for conducting water, minerals, and photosynthetic products through the plant. Higher plants include the ferns, clubmosses, horsetails, flowering plants, conifers and other gymnosperms. In sharp phenotypic and genotypic contrast are the lower (nonvascular) plants, which include both earlier derived lineages in Plantae (e.g., mosses, hornworts, and liverworts) and members of other kingdoms (the various algae).

Potential uses include, but are not limited to, control of weeds in industrial or railway sites; homeowner uses for eradication of plants in mulched areas or around paths, trees or fences; and use in agricultural fields for burndown of weeds before planting or crop emergence. Exemplary mono- and dicotyledonous plant families include, but are not limited to, Cyperaceae, Poaceae, Pontaderiaceae, Portulacaceae, Chenopodiaceae, Convolvulaceae, Amaranthaceae and Rubiaceae.

Compositions of the present invention include aqueous solutions of the tetraalkyl ammonium halide, e.g. any of those described above. Typical compositions will include tetraalkyl ammonium halide at a concentration of at least 0.5%. More typical compositions will have a tetraalkyl ammonium halide concentration in the range of 1.0% to 35%. Ranges disclosed herein are considered to include any and all subranges between (and inclusive of) the minimum value of 0.5% and the maximum value of 35%; that is, all subranges beginning with a minimum value of 0.5% or more, e.g. 0.5% to 25%, and ending with a maximum value of 35% or less, e.g. 4.5% to 35%, as well as all ranges beginning and ending with the end points, e.g. 1% to 10%, 2% to 9%, 3% to 8%, 3% to 9%, 4% to 7%, and finally to each number, e.g. 1%, 2%, 3%, 4%, 5%, 6%, 7%, 8%, 9% and 10% etc., including subsets within those ranges, and about 0.6% to about 25%, and 1.5% to 10%.

Compositions may optionally comprise additional surface active agents, e.g. agents to improve at least one of the dispersing/emulsifying, absorbing, spreading, sticking and/or pest-penetrating properties of the composition. Exemplary surface active agents include non-ionic surfactants, crop oil concentrates, nitrogen-surfactant blends, esterified seed oils, organosilicones, etc.

The tetraalkyl ammonium salt active ingredients are commercially available from a number of suppliers as aqueous solutions in concentrations ranging up to 80%. These concentrates may contain up to about 20% of ethanol as a stabilizer. Examples of commercially available products include the BTC® series from Stepan Company, The Bardac® series from Lonza Group Ltd. or the Maquat series from Mason Chemical Company. The inventive compositions may be prepared by dilution of the aqueous concentrate to the desired concentration with water and stirring vigorously to ensure complete mixing.

Another embodiment of the current disclosure is a method of use of a herbicidally effective dose of a compound of the present disclosure in combination with one or more other herbicides, and optionally other surface active additives, for non-selective control of higher terrestrial plants. Glyphosate, especially in the form of its agriculturally active salts, is a preferred mixing partner for the herbicidal compositions disclosed herein. Useful ratios, based on weight percent, of the quaternary salts of the present invention to the glyphosate additive, will range from about 15:1 to about 1:1. In one example, the range will be from about 8:1 to about 2:1. In another example, the range will be from about 8:1 to about 4:1. In compositions comprising glufosinate, the range will be, in one example, from about 12:1 to about 1:1, in another example, from about 4:1 to about 2:1. Concentration ranges may be similar for other composition examples having other herbicides.

The following examples illustrate the herbicidal properties and methods of use of the inventive compositions, but should not be considered limitative of the scope of the invention.

### Example I

### Preparation of 2% DDAC Composition

A quantity (8 grams) of 50% concentrate of didecyl dimethyl ammonium chloride (CAS #7173-51-5) was diluted with water (192 grams) while stirring vigorously until completely mixed.

### Example II

A single plant of creeping speedwell (Veronica filiformis) was sprayed with the composition of Example I until the leaves of the plant were wetted with solution. Temperature at time of application was 59° F., and no rainfall occurred during the first 24 hours of the trial period. Ratings of the herbicidal effects were made over time after application on a 1 to 10 scale as follows: 0=no effect, 5=50%, 10=100%. Results are shown in the table below.

| Days | Rating |
|---|---|
| 1 | 1 |
| 2 | 3 |
| 3 | 4 |
| 4 | 5 |
| 5 | 7 |
| 6 | 8 |
| 7 | 9 |

### Example III

A single plant of common chickweed (Stellaria media) was sprayed with the composition of Example I until the leaves of the plant were wetted with solution. Temperature at time of application was 78° F. Ratings of the herbicidal effects were made over time after application on a 1 to 10 scale as follows: 0=no effect, 5=50%, 10=100%. Results are shown in the table below.

| Days | Rating |
|---|---|
| 1 | 2 |
| 2 | 4 |
| 3 | 6 |
| 4 | 7 |
| 5 | 7.5 |
| 6 | 8 |
| 7 | 9 |

### Example IV

A single plant of henbit (Lamium amplexicaule) was sprayed with the composition of Example I until the leaves of the plant were wetted with solution. Temperature at time of application was 47° F., and no rainfall occurred during the first 24 hours of the trial period. Ratings of the herbicidal effects were made over time after application on a 1 to 10 scale as follows: 0=no effect, 5=50%, 10=100%. Results are shown in the table below.

| Days | Rating |
|---|---|
| 1 | 1 |
| 2 | 2 |
| 3 | 3 |
| 4 | 4 |
| 5 | 6 |
| 6 | 7 |
| 7 | 8 |
| 12 | 9 |
| 14 | 10 |

### Example V

### Preparation of 1% DDAC Composition

A quantity (6 grams) of 50% concentrate of didecyl dimethyl ammonium chloride (CAS #7173-51-5) was diluted with water (294 grams) while stirring vigorously until completely mixed.

### Example VI

A single plant of henbit (Lamium amplexicaule) was sprayed with the composition of Example V until the leaves of the plant were wetted with solution. Temperature at time of application was 67° F., and no rainfall occurred during the first 24 hours of the trial period. Ratings of the herbicidal effects were made over time after application on a 1 to 10 scale as follows: 0=no effect, 5=50%, 10=100%. Results are shown in the table below.

| Days | Rating |
|---|---|
| 1 | 1 |
| 2 | 2 |
| 3 | 6 |
| 4 | 8 |
| 5 | 8.5 |
| 6 | 9 |
| 7 | 10 |

Hager and Sprague (University of Illinois, Pest Management and Crop Development Bulletin, Issue 5, 2003—FIG. 4) have found that control of henbit was less than 50% with both paraquat and glyphosate post-emergence herbicides when applications were made at temperatures below 76° F. In light of this report, the herbicidal activity results of Example IV and Example VI with compositions of the present invention are quite surprising.

### Example VII

A small area (one square foot) of vigorously growing bermudagrass (Cynodon dactylon) was sprayed with the composition of Example I until the leaves of the grass were wetted. Temperature at time of application was 91° F., and no rainfall occurred during the first 24 hours of the trial period.

Ratings of the desiccation effects were made over time after application on a 1 to 10 scale as follows: 0=no effect, 5=50%, 10=100%. Results are shown in the table below.

| Days | Rating |
|---|---|
| 1 | 6 |
| 2 | 6.5 |
| 3 | 7 |
| 4 | 7.5 |
| 5 | 8 |
| 6 | 8 |
| 7 | 8 |
| 8 | 7.5 |
| 9 | 6 |
| 10 | 5.5 |
| 11 | 4.5 |
| 12 | 3 |
| 13 | 2 |
| 14 | 1.5 |

### Example VIII

### Preparation of 2% DDAC Plus 0.5% Glyposate IPA Salt Composition

A quantity (12 grams) of 50% concentrate of didecyl dimethyl ammonium chloride (CAS #7173-51-5) was mixed with 78 grams of 1.92% glyphosate IPA salt solution (Ace Ready-to-Use Weed & Grass Killer), and this mixture was diluted with 218 grams of water while stirring vigorously until completely mixed.

### Example VIX

A small area (one square foot) of vigorously growing bermudagrass (Cynodon dactylon) was sprayed with the composition of Example VIII until the leaves of the grass were thoroughly wetted. Temperature at time of application was 91° F., and no rainfall occurred within 24 hours after application. Ratings of the desiccation effects were made over time after application on a 1 to 10 scale as follows: 0=no effect, 5=50%, 10=100%. Results are shown in the table below.

| Days | Rating |
|---|---|
| 1 | 6 |
| 2 | 6.5 |
| 3 | 7 |
| 4 | 8 |
| 5 | 9 |
| 6 | 9 |
| 7 | 9.3 |
| 8 | 9.3 |
| 9 | 9.5 |
| 10 | 9.7 |
| 11 | 9.7 |
| 12 | 9.8 |
| 13 | 9.8 |
| 14 | 9.7 |

As demonstrated by the experiments outlined above, the compositions of the present invention elicit rapid herbicidal effects enabling fast and effective control of a range of undesirable terrestrial plants and offer benefits vs. established commercial standards. It is understood that the specification and examples are illustrative but not limitative of the present invention and that other embodiments within the spirit and scope of the invention will suggest themselves to those skilled in the art.

I claim:

1. A method for control of an unwanted higher terrestrial plant, the method comprising:
applying to the terrestrial plant a herbicidally effective amount of a tetraalkyl ammonium halide(s) of the chemical formula below
R₁R₂N(+)R₃R₄X(−)
wherein, R₁ and R₂ are each independently C₁ to C₄ alkyl; R₃ and R₄ are each independently C₈ to C₁₆ alkyl; X is chloride or bromide.

2. The method of claim 1 wherein R₁ and R₂ are methyl; R₃ and R₄ are C₁₀ alkyl; and
X is chloride.

4. The method of claim 1, further including adding at least one surface active additive.

5. The method of claim 1, wherein the terrestrial plant includes specialized tissues for conducting water, minerals, and photosynthetic products through the plant.

6. The method of claim 1, wherein the herbicidally effective amount includes at least 0.5% of the at least one tetraalkyl ammonium halide.

7. The method of claim 1, wherein the herbicidally effective amount includes at least one amount in the range of 0.5% to 35% of the at least one tetralkyl ammonium halide.

8. A method for control of an unwanted higher terrestrial plant, the method comprising:
applying to the terrestrial plant a composition comprising
a herbicidally effective amount of a tetraalkyl ammonium halide(s) of the chemical formula below
R₁R₂N(+)R₃R₄X(−)
wherein, R₁ and R₂ are each independently C₁ to C₄ alkyl; R₃ and R₄ are each independently C₈ to C₁₆ alkyl; X is chloride or bromide; and
at least one additional herbicide.

9. The method of claim 8, wherein the composition includes at least one additional surface active additive.

10. The method of claim 8 wherein the at least one additional herbicide includes glyphosate, or an agriculturally active salt thereof.

11. The method of claim 10 wherein, the ratio, based on weight percent, of the quaternary salt to glyphosate, or an agriculturally active salt thereof, is between 15:1 and 1:1.

12. The method of claim 11 wherein, the ratio, based on weight percent, of the quaternary salt to glyphosate, or an agriculturally active salt thereof, is between 15:1 and 3:1.

13. The method of claim 8, wherein the terrestrial plant includes specialized tissues for conducting water, minerals, and photosynthetic products through the plant.

14. The method of claim 8, wherein the herbicidally effective amount includes at least 0.5% of the at least one tetraalkyl ammonium halide.

15. The method of claim 8, wherein the herbicidally effective amount includes at least one amount in the range of 0.5% to 35% of the at least one tetralkyl ammonium halide.

16. A method for control of an unwanted higher terrestrial plant, the method comprising:
applying to the unwanted terrestrial plant a herbicidally effective amount of a tetraalkyl ammonium halide(s) of the chemical formula below
R1R2N(+)R3R4X(−)
wherein, R1 and R2 are each independently C1 to C4 alkyl; R3 and R4 are each independently C8 to C16 alkyl; X is chloride or bromide, and
obtaining the demise of the unwanted terrestrial plant as a result of the application.
